(19) United States
(12) Patent Application Publication
(10) Pub. No.: US 2021/0341806 A1
(43) Pub. Date: Nov. 4, 2021

(54) LIQUID CRYSTAL PANEL AND MANUFACTURING METHOD THEREOF

(71) Applicant: TCL CHINA STAR OPOELECTRONICS TECHNOLOGY CO., LTD., Shenzhen (CN)

(72) Inventor: Yun YU, Shenzhen (CN)

(73) Assignee: TCL CHINA STAR OPTOELECTRONICS TECHNOLOGY CO., LTD., Shenzhen (CN)

(21) Appl. No.: 16/619,470

(22) PCT Filed: Nov. 12, 2019
(86) PCT No.: PCT/CN2019/117373

§ 371 Date: Dec. 5, 2019

(30) Foreign Application Priority Data
Sep. 12, 2019 (CN) 201910863294.3

(51) Int. Cl. G02F 1/1362; G02F 1/1368

(52) U.S. Cl. CPC G02F 1/136222; G02F 1/1368; G02F 1/136209

(57) ABSTRACT

A liquid crystal panel provided by some embodiments of the present disclosure includes: a color filter substrate and an array substrate disposed opposite to each other; and a sealant disposed between the color filter substrate and the array substrate. Liquid crystals are disposed in a region surrounded by the color filter substrate, the array substrate, and the sealant, to form a liquid crystal layer. The liquid crystal panel includes an active area, and a non-active area disposed around a periphery of the active area. A light shielding layer is disposed on a side of a portion of the color filter substrate. The portion of the color filter substrate is located in the non-active area, and the side of the portion of the color filter substrate is away from the liquid crystal layer. The solution may enhance a curing effect of the sealant.

### FIELD OF INVENTION

The present disclosure relates to a technical field of displays, and more particularly to a liquid crystal display panel and manufacturing method thereof.

### BACKGROUND OF INVENTION

A liquid crystal panel is formed by an array substrate, a color filter substrate, a liquid crystal layer between the two substrates, and a plurality of corresponding polarizer films attached to a plurality of corresponding surfaces of the two substrates. In typical liquid crystal panels, in order to prevent light leakage, black matrices (BMs) are commonly used to block non-active areas of liquid crystal panels. Because BMs are present on color filter substrate sides of non-active areas, sealants cannot be light-cured from color filter substrate sides, and need to be cured from array substrate sides.

However, there are a large number of metal signal lines at a sealant location of an array substrate side. In order to normally cure a sealant with light, a metal aperture ratio of a sealant coated region is commonly required to be greater than 45%. However, even if the aperture ratio reaches 45%, a curing effect of the sealant is still difficult to be up to standard. Therefore, it is easy for abnormalities such as liquid crystals polluted by the sealant, and separation of the array substrate and the color filter substrate because of insufficient tension of the sealant to occur.

### SUMMARY OF INVENTION

Technical problems are as follows. There are a large number of metal signal lines at a sealant location of an array substrate side. In order to normally cure a sealant with light, a metal aperture ratio of a sealant coated region is commonly required to be greater than 45%. However, even if the aperture ratio reaches 45%, a curing effect of the sealant is still difficult to be up to standard. Therefore, it is easy for abnormalities such as liquid crystals polluted by the sealant, and separation of the array substrate and the color filter substrate because of insufficient tension of the sealant to occur.

Technical solutions are as follows. Some embodiments of the present disclosure provide a liquid crystal display panel and manufacturing method thereof, which may enhance a curing effect of a sealant.

In a first aspect, some embodiments of the present disclosure provide a liquid crystal panel, including: a color filter substrate and an array substrate disposed opposite to each other; and a sealant disposed between the color filter substrate and the array substrate. Liquid crystals are disposed in a region surrounded by the color filter substrate, the array substrate, and the sealant, to form a liquid crystal layer. The liquid crystal panel includes an active area, and a non-active area disposed around a periphery of the active area. The color filter substrate includes a first portion located in the active area, and a second portion located in the non-active area. A light shielding layer is disposed on a side of the second portion of the color filter substrate. The second portion of the color filter substrate is located in the non-active area, and the side of the second portion of the color filter substrate is away from the liquid crystal layer.

In the liquid crystal panel provided by some embodiments of the present disclosure, the liquid crystal panel further includes a first polarizer film disposed on a side of the color filter substrate. The side of the color filter substrate is away from the liquid crystal layer.

In the liquid crystal panel provided by some embodiments of the present disclosure, the first polarizer film is disposed between the light shielding layer and the color filter substrate.

In the liquid crystal panel provided by some embodiments of the present disclosure, the first polarizer film is disposed on a side of the light shielding layer; and wherein the side of the light shielding layer is away from the color filter substrate.

In the liquid crystal panel provided by some embodiments of the present disclosure, the first portion of the color filter substrate has a black matrix. The first portion of the color filter substrate is located in the active area. The second portion of the color filter substrate does not have a black matrix. The second portion of the color filter substrate is located in the non-active area.

In the liquid crystal panel provided by some embodiments of the present disclosure, the light shielding layer includes a black light shielding material.

In the liquid crystal panel provided by some embodiments of the present disclosure, the black light shielding material includes a carbon black.

In the liquid crystal panel provided by some embodiments of the present disclosure, the array substrate is a thin film transistor array substrate.

In the liquid crystal panel provided by some embodiments of the present disclosure, the liquid crystal panel further includes an alignment layer disposed on the color filter substrate and/or the array substrate. The alignment layer is in contact with the liquid crystal layer.

In a second aspect, some embodiments of the present disclosure provide a method of manufacturing a liquid crystal panel, including:

providing a color filter substrate and an array substrate;

dropping corresponding liquid crystals into each of a plurality of spaced regions on the color filter substrate or the array substrate, and coating the color filter substrate or the array substrate with a corresponding sealant around a corresponding periphery of the corresponding liquid crystals of each region, to form a corresponding liquid crystal layer;

assembling the color filter substrate and the array substrate; wherein the color filter substrate and the array substrate include a plurality of active areas, and a plurality of corresponding non-active areas disposed around a plurality of corresponding peripheries of the active areas and disposed opposite to the active areas; and wherein the color filter substrate includes a plurality of first portions located in the corresponding active areas and a plurality of second portions located in the corresponding non-active areas; and

disposing a corresponding light shielding layer on a corresponding side of each second portion of the color filter substrate; wherein each second portion of the color filter substrate is located in the corresponding non-active area, and the corresponding side of each second portion of the color filter substrate is away from the corresponding liquid crystal layer.

In the method of manufacturing the liquid crystal panel provided by some embodiments of the present disclosure, after the color filter substrate and the array substrate are assembled, and before the corresponding light shielding layer is disposed on the corresponding side of each second portion of the color filter substrate, the method further includes:

curing each sealant with ultraviolet (UV) light, wherein each sealant is cured from a color filter substrate side.

In the method of manufacturing the liquid crystal panel provided by some embodiments of the present disclosure, after each sealant is cured, the method further includes:

performing, from the color filter substrate side, photoalignment on the corresponding liquid crystals of each region.

In the method of manufacturing the liquid crystal panel provided by some embodiments of the present disclosure, after the photoalignment is performed, from the color filter substrate side, on the corresponding liquid crystals of each region, the method further includes:

disposing each first polarizer film on a side of the color filter substrate, and disposing each second polarizer film on a side of the array substrate;

wherein the side of the color filter substrate is away from each liquid crystal layer; and wherein the side of the array substrate is away from each liquid crystal layer.

In the method of manufacturing the liquid crystal panel provided by some embodiments of the present disclosure, each first polarizer film is disposed between the corresponding light shielding layer and the color filter substrate.

In the method of manufacturing the liquid crystal panel provided by some embodiments of the present disclosure, each first polarizer film is disposed on a corresponding side of the corresponding light shielding layer. The corresponding side of the corresponding light shielding layer is away from the color filter substrate.

In the method of manufacturing the liquid crystal panel provided by some embodiments of the present disclosure, each first portion of the color filter substrate has a corresponding black matrix. Each first portion of the color filter substrate is located in the corresponding active area. Each second portion of the color filter substrate does not have a corresponding black matrix. Each second portion of the color filter substrate is located in the corresponding non-active area.

In the method of manufacturing the liquid crystal panel provided by some embodiments of the present disclosure, each light shielding layer includes a corresponding black light shielding material.

In the method of manufacturing the liquid crystal panel provided by some embodiments of the present disclosure, each black light shielding material includes a corresponding carbon black.

In the method of manufacturing the liquid crystal panel provided by some embodiments of the present disclosure, the array substrate is a thin film transistor array substrate.

In the method of manufacturing the liquid crystal panel provided by some embodiments of the present disclosure, the liquid crystal panel further includes a plurality of alignment layers disposed on the color filter substrate and/or the array substrate. Each alignment layer is in contact with the corresponding liquid crystal layer.

Advantageous effects are as follows. A liquid crystal panel provided by some embodiments of the present disclosure includes: a color filter substrate and an array substrate disposed opposite to each other; and a sealant disposed between the color filter substrate and the array substrate. Liquid crystals are disposed in a region surrounded by the color filter substrate, the array substrate, and the sealant, to form a liquid crystal layer. The liquid crystal panel includes an active area, and a non-active area disposed around a periphery of the active area. The color filter substrate includes a first portion located in the active area, and a second portion located in the non-active area. A light shielding layer is disposed on a side of the second portion of the colorfilter substrate. The second portion of the color filter substrate is located in the non-active area, and the side of the second portion of the color filter substrate is away from the liquid crystal layer. The solution may enhance a curing effect of the sealant.

### DESCRIPTION OF DRAWINGS

FIG. 1 is a schematic diagram illustrating a structure of a liquid crystal panel provided by some embodiments of the present disclosure.

FIG. 2 is a schematic diagram illustrating another structure of the liquid crystal panel provided by some embodiments of the present disclosure.

FIG. 3 is a schematic flowchart of a method of manufacturing a liquid crystal panel provided by some embodiments of the present disclosure.

### DETAILED DESCRIPTION OF PREFERRED EMBODIMENTS

Technical solutions in the embodiments of the present disclosure are clearly and completely described below in conjunction with the drawings in the embodiments of the present disclosure. Obviously, the described embodiments are only a portion of the embodiments of the present disclosure, not all of the embodiments. Based on the embodiments of the present disclosure, other embodiments obtained under a premise that inventive efforts are not made by persons of ordinary skill in the art are within the protection scope of the present disclosure.

Some embodiments of the present disclosure provide a display panel and a display device, which are respectively described in detail below.

Some embodiments of the present disclosure provide a liquid crystal panel and manufacturing method thereof, which are respectively described in detail below.

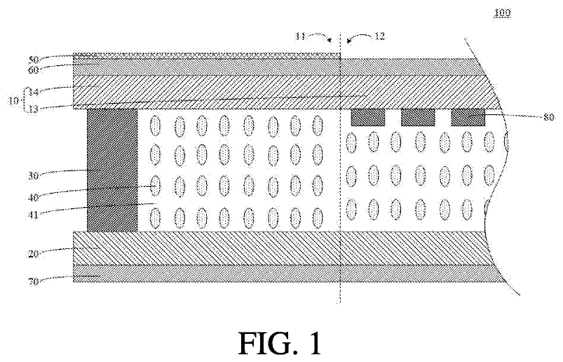

Referring to FIG. 1, FIG. 1 is a schematic diagram illustrating a structure of a liquid crystal panel provided by some embodiments of the present disclosure. The liquid crystal panel 100 includes a color filter substrate 10 and an array substrate 20 disposed opposite to each other, and a sealant 30 disposed between the color filter substrate 10 and the array substrate 20. Liquid crystals 40 are disposed in a region surrounded by the color filter substrate 10, the array substrate 20, and the sealant 30, to form a liquid crystal layer 41. The liquid crystal panel 100 includes an active area 12, and a non-active area 11 disposed around a periphery of the active area 12. The color filter substrate 10 includes a first portion 13 located in the active area 12, and a second portion 14 located in the non-active area 11. A light shielding layer 50 is disposed on a side of the second portion 14 of the color filter substrate 10. The second portion 14 of the color filter substrate 10 is located in the non-active area 11, and the side of the second portion 14 of the color filter substrate 10 is away from the liquid crystal layer 41.

The array substrate 10 is a thin film transistor array substrate.

The light shielding layer 50 includes a black light shielding material, such as a carbon black.

Each liquid crystal 40 includes a plurality of liquid crystal molecules.

At least one of the color filter substrate 10 and the array substrate 20 is coated with a polymer solution, to form an alignment layer. The alignment layer is in contact with the liquid crystal layer 41.

In some embodiments, the liquid crystal panel 100 further includes a first polarizer film 60 and a second polarizer film 70. The first polarizer film 60 is disposed on a side of the color filter substrate 10. The side of the color filter substrate 10 is away from the liquid crystal layer 41. The second polarizer film 70 is disposed on a side of the array substrate 20. The side of the array substrate 20 is away from the liquid crystal layer 41.

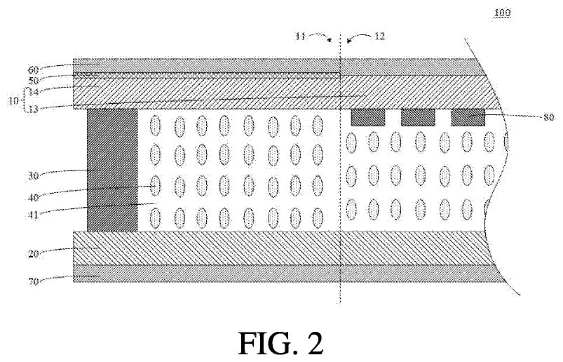

It is to be noted that as illustrated in FIG. 1, the first polarizer film 60 is disposed between the light shielding layer 60 and the color filter substrate 10. As illustrated in FIG. 2, the first polarizer film 60 may also be disposed on a side of the light shielding layer 60. The side of the light shielding layer 60 is away from the color filter substrate 10.

It is to be noted that in some embodiments of the present disclosure, the first portion 13 of the color filter substrate 10 has a black matrix 80. The first portion 13 of the color filter substrate 10 is located in the active area 12. The second portion 14 of the color filter substrate 10 does not have a black matrix 80. The second portion 14 of the color filter substrate 10 is located in the non-active area 11.

In summary, the second portion 14 of the color filter substrate 10 of the liquid crystal panel 100 does not have a black matrix 80. The second portion 14 of the color filter substrate 10 is located in the non-active area 11. Therefore, both of the active area 12 and the non-active area 11 of the color filter substrate 10 have a plurality of better corresponding light transmission performances. Hence, when the sealant 30 is cured with ultraviolet (UV) light, the sealant 30 is cured from a color filter substrate 10 side, so that the sealant 30 may be sufficiently cured. In this way, tension of the sealant is increased, thereby avoiding separation of the color filter substrate 10 and the array substrate 20.

Also, it is not necessary to cure the sealant 30 from an array substrate 20 side. Therefore, in some embodiments of the present disclosure, there is no aperture ratio requirement for metal signal lines at a sealant region of the array substrate 10 side. A space of the metal signal lines may compress, facilitating narrow bezel design of the liquid crystal panel 100.

Also, both of the active area 12 and the non-active area 11 of the color filter substrate 10 have the better corresponding light transmission performances. Thus, it is ensured that the alignment layer in a region from an inner edge of the sealant 30 to the active area 12 is sufficiently cured. As a result, the liquid crystal molecules exhibit a fixed pretilt angle, thereby preventing luminance unevenness from existing in the region from the inner edge of the sealant 30 to the active area 12. The region from the inner edge of the sealant 30 to the active area 12 is in the active area 12 of the liquid crystal panel 100. Then, the light shielding layer 50 is disposed on a side of the second portion 14 of the color filter substrate 10. The second portion 14 of the color filter substrate 10 is located in the non-active area 11, and the side of the second portion 14 of the color filter substrate 10 is away from the liquid crystal layer 41. In this way, it is ensured that the non-active area 11 of the liquid crystal panel 100 is prevented from leaking light. Therefore, display quality is better.

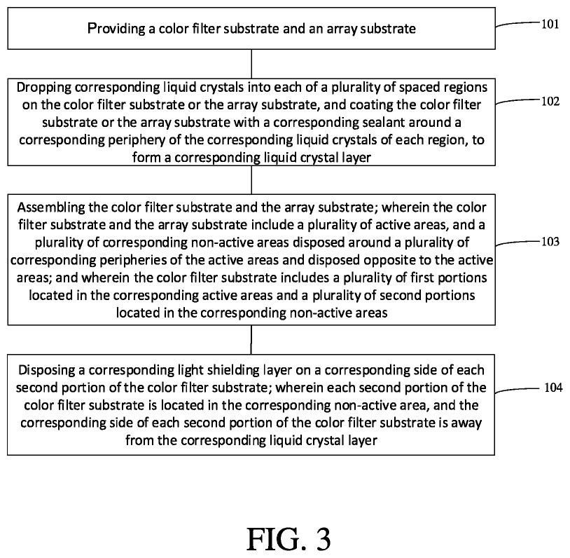

Referring to FIG. 3, FIG. 3 is a schematic flowchart of a method of manufacturing a liquid crystal panel provided by some embodiments of the present disclosure. A specific flowchart of the method of manufacturing the liquid crystal panel 100 is as follows.

In a step 101, a color filter substrate 10 and an array substrate 20 are provided.

In a step 102, corresponding liquid crystals 40 are dropped into each of a plurality of spaced regions on the color filter substrate 10 or the array substrate 20, and the color filter substrate 10 or the array substrate 20 is coated with a corresponding sealant 30 around a corresponding periphery of the corresponding liquid crystals 40 of each region, to form a corresponding liquid crystal layer 41.

In a step 103, the color filter substrate 10 and the array substrate 20 are assembled. The color filter substrate 10 and the array substrate 20 include a plurality of active areas 12, and a plurality of corresponding non-active areas 11 disposed around a plurality of corresponding peripheries of the active areas 12 and disposed opposite to the active areas 12. The color filter substrate 10 includes a plurality of first portions 13 located in the corresponding active areas 12 and a plurality of second portions 14 located in the corresponding non-active areas 11.

In a step 104, a corresponding light shielding layer 50 is disposed on a corresponding side of each second portion 14 of the color filter substrate 10. Each second portion 14 of the color filter substrate 10 is located in the corresponding non-active area 11, and the corresponding side of each second portion 14 of the color filter substrate 10 is away from the corresponding liquid crystal layer 41.

In some embodiments, after the color filter substrate 10 and the array substrate 20 are assembled, and before the corresponding light shielding layer 50 is disposed on the corresponding side of each second portion 14 of the color filter substrate 10, the method further includes:

curing each sealant 30 with UV light, wherein each sealant 30 is cured from a color filter substrate 10 side.

Specifically, before each sealant 30 is UV-cured from the color filter substrate 10 side, a photomask is disposed on a side of the color filter substrate 10 and above the liquid crystal layer 41 in advance. That is, when each sealant 30 is UV-cured, only each sealant 30 is exposed to the UV light. Thereafter, each sealant 30 is UV-irradiated from the color filter substrate 10 side, to finish curing each sealant 30.

In some embodiments, after each sealant 30 is UV-cured from the color filter substrate 10 side, the method further includes:

performing, from the color filter substrate 10 side, photoalignment on the corresponding liquid crystals 40 of each region.

Specifically, the photomask disposed on the side of the color filter substrate 10 and above the liquid crystal layer 41 is removed, and then, an exposed portion is UV-irradiated from the color filter substrate 10 side, to cause a plurality of corresponding liquid crystal molecules of each liquid crystal 40 to exhibit a corresponding fixed pretilt angle. Therefore, the photoalignment is finished.

In some embodiments, after the photoalignment is performed, from the color filter substrate 10 side, on the corresponding liquid crystals 40 of each region, the method further includes:

Each first polarizer film 60 is disposed on a side of the color filter substrate 10, and each second polarizer film 70 is disposed on a side of the array substrate 20. The side of the color filter substrate 10 is away from each liquid crystal layer 41. The side of the array substrate 20 is away from each liquid crystal layer 41.

In summary, the method of manufacturing the liquid crystal panel provided by some embodiments of the present disclosure removes causing each second portion of the color filter substrate to have a corresponding black matrix. Each second portion of the color filter substrate is located in the corresponding non-active area. Hence, both of each active area and the corresponding non-active area of the color filter substrate have a plurality of better corresponding light transmission performances, respectively. Thus, in some embodiments of the present disclosure, each sealant is cured from the color filter substrate side, so that each sealant may be sufficiently cured. In this way, tension of each sealant is increased, thereby avoiding separation of the color filter substrate and the array substrate. Also, it is not necessary to cure each sealant from the array substrate side. Therefore, in some embodiments of the present disclosure, there is no aperture ratio requirement for corresponding metal signal lines at each of a plurality of sealant regions of the array substrate side. A corresponding space of the corresponding metal signal lines may compress, facilitating narrow bezel design of the liquid crystal panel.

Also, both of each active area and the corresponding non-active area of the color filter substrate have the better corresponding light transmission performances, respectively. Thus, it is ensured that a corresponding alignment layer in a corresponding region from a corresponding inner edge of the corresponding sealant to each active area is sufficiently cured. As a result, the corresponding liquid crystal molecules of each of the corresponding liquid crystals exhibit the corresponding fixed pretilt angle, thereby preventing luminance unevenness from existing in the corresponding region from the corresponding inner edge of the corresponding sealant to each active area. The corresponding region from the corresponding inner edge of the corresponding sealant to each active area is in each active area of the liquid crystal panel.

In the foregoing embodiments, the description of each embodiment has corresponding focuses. For a part that is not described in detail in an embodiment, refer to corresponding related descriptions in other embodiments.

Some embodiments of the liquid crystal panel and manufacturing method thereof according to the present disclosure have been described in detail above. The principles and implementation manners of the present disclosure are described using specific examples. The description of the foregoing embodiments is only for facilitating understanding of the technical solutions of the present disclosure and the core ideas thereof. Persons of ordinary skill in the art should understand that the technical solution described in each of the foregoing embodiments may be modified, or at least one technical feature described in each of the foregoing embodiments may be replaced by at least one equivalent alternative. The modification or the at least one alternative should not cause the essence of the corresponding technical solution to depart from the scope of the technical solution of each embodiment of the present disclosure.

What is claimed is:

1. A liquid crystal panel, comprising:
a color filter substrate and an array substrate disposed opposite to each other; and
a sealant disposed between the color filter substrate and the array substrate; wherein liquid crystals are disposed in a region surrounded by the color filter substrate, the array substrate, and the sealant, to form a liquid crystal layer; wherein the liquid crystal panel comprises an active area, and a non-active area disposed around a periphery of the active area; wherein the color filter substrate comprises a first portion located in the active area, and a second portion located in the non-active area; and wherein a light shielding layer is disposed on a side of the second portion of the color filter substrate; wherein the second portion of the color filter substrate is located in the non-active area, and the side of the second portion of the color filter substrate is away from the liquid crystal layer.

2. The liquid crystal panel of claim 1, wherein the liquid crystal panel further comprises a first polarizer film disposed on a side of the color filter substrate; and wherein the side of the color filter substrate is away from the liquid crystal layer.

3. The liquid crystal panel of claim 2, wherein the first polarizer film is disposed between the light shielding layer and the color filter substrate.

4. The liquid crystal panel of claim 2, wherein the first polarizer film is disposed on a side of the light shielding layer; and wherein the side of the light shielding layer is away from the color filter substrate.

5. The liquid crystal panel of claim 1, wherein the first portion of the color filter substrate has a black matrix; wherein the first portion of the color filter substrate is located in the active area; wherein the second portion of the color filter substrate does not have a black matrix; and wherein the second portion of the color filter substrate is located in the non-active area.

6. The liquid crystal panel of claim 1, wherein the light shielding layer comprises a black light shielding material.

7. The liquid crystal panel of claim 6, wherein the black light shielding material comprises a carbon black.

8. The liquid crystal panel of claim 1, wherein the array substrate is a thin film transistor array substrate.

9. The liquid crystal panel of claim 1, wherein the liquid crystal panel further comprises an alignment layer disposed on the color filter substrate and/or the array substrate; and wherein the alignment layer is in contact with the liquid crystal layer.

10. A method of manufacturing a liquid crystal panel, comprising:
providing a color filter substrate and an array substrate;
dropping corresponding liquid crystals into each of a plurality of spaced regions on the color filter substrate or the array substrate, and coating the color filter substrate or the array substrate with a corresponding sealant around a corresponding periphery of the corresponding liquid crystals of each region, to form a corresponding liquid crystal layer;
assembling the color filter substrate and the array substrate; wherein the color filter substrate and the array substrate comprise a plurality of active areas, and a plurality of corresponding non-active areas disposed around a plurality of corresponding peripheries of the active areas and disposed opposite to the active areas; and wherein the color filter substrate comprises a plurality of first portions located in the corresponding active areas and a plurality of second portions located in the corresponding non-active areas; and
disposing a corresponding light shielding layer on a corresponding side of each second portion of the color filter substrate; wherein each second portion of the color filter substrate is located in the corresponding non-active area, and the corresponding side of each second portion of the color filter substrate is away from the corresponding liquid crystal layer.

11. The method of manufacturing the liquid crystal panel of claim 10, wherein after the color filter substrate and the array substrate are assembled, and before the corresponding light shielding layer is disposed on the corresponding side of each second portion of the color filter substrate, the method further comprises:
curing, from a color filter substrate side, each sealant with ultraviolet (UV) light.

12. The method of manufacturing the liquid crystal panel of claim 11, wherein after each sealant is cured, the method further comprises:
performing, from the color filter substrate side, photoalignment on the corresponding liquid crystals of each region.

13. The method of manufacturing the liquid crystal panel of claim 12, wherein after the photoalignment is performed, from the color filter substrate side, on the corresponding liquid crystals of each region, the method further comprises:
disposing each first polarizer film on a side of the color filter substrate, and disposing each second polarizer film on a side of the array substrate; wherein the side of the color filter substrate is away from each liquid crystal layer; and wherein the side of the array substrate is away from each liquid crystal layer.

14. The method of manufacturing the liquid crystal panel of claim 13, wherein each first polarizer film is disposed between the corresponding light shielding layer and the color filter substrate.

15. The method of manufacturing the liquid crystal panel of claim 14, wherein each first polarizer film is disposed on a corresponding side of the corresponding light shielding layer; wherein the corresponding side of the corresponding light shielding layer is away from the color filter substrate.

16. The method of manufacturing the liquid crystal panel of claim 10, wherein each first portion of the color filter substrate has a corresponding black matrix; wherein each first portion of the color filter substrate is located in the corresponding active area; wherein each second portion of the color filter substrate does not have a corresponding black matrix; and wherein each second portion of the color filter substrate is located in the corresponding non-active area.

17. The method of manufacturing the liquid crystal panel of claim 10, wherein each light shielding layer comprises a corresponding black light shielding material.

18. The method of manufacturing the liquid crystal panel of claim 17, wherein each black light shielding material comprises a corresponding carbon black.

19. The method of manufacturing the liquid crystal panel of claim 10, wherein the array substrate is a thin film transistor array substrate.

20. The method of manufacturing the liquid crystal panel of claim 10, wherein the liquid crystal panel further comprises a plurality of alignment layers disposed on the color filter substrate and/or the array substrate; and wherein each alignment layer is in contact with the corresponding liquid crystal layer.
